(19) United States
(12) Patent Application Publication
(10) Pub. No.: US 2026/0168398 A1
(43) Pub. Date: Jun. 18, 2026

(54) SYSTEM AND METHOD FOR CLEANING GAS TURBINE ENGINES

(71) Applicant: General Electric Company, Evendale, OH (US)

(72) Inventors: Paul Mathew, Bengaluru (IN); David Raju Yamarthi, Bengaluru (IN); Ravindra Shankar Ganiger, Bengaluru (IN); Kirti Arvind Petkar, Bangalore (IN); Andrew Crispin Graham, Badminton (GB); Krishna Ramadurai, Bengaluru (IN)

(21) Appl. No.: 19/259,038

(22) Filed: Jul. 3, 2025

(30) Foreign Application Priority Data
Dec. 13, 2024 (IN) 202411098692

(51) Int. Cl. F01D 25/00; B08B 6/00; B08B 9/00

(52) U.S. Cl. CPC F01D 25/002; B08B 6/00; B08B 9/00; F05D 2220/32

(57) ABSTRACT

A system for cleaning gas turbine engines includes at least one particle cleaning medium reservoir for storing at least one particle cleaning medium. The at least one particle cleaning medium includes at least one of a first plurality of organic particles or a second plurality of organic particles, with each of the first plurality of organic particles being dissolvable, and with each of the second plurality of organic particles having fibers. The system further includes a delivery system being configured to direct the at least one particle cleaning medium from the at least one particle cleaning medium reservoir towards one or more components of a gas turbine engine for cleaning the one or more components of the gas turbine engine.

### FIELD

The present disclosure relates to gas turbine engines and, more particularly, to a system and related method for cleaning gas turbine engines, or components thereof, using abrasive particles.

### BACKGROUND

Typical aircraft propulsion systems include one or more gas turbine engines. For certain propulsion systems, the gas turbine engines generally include a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere.

During operation, a substantial amount of air is ingested by such gas turbine engines. However, such air may contain foreign particles. While a majority of the foreign particles will follow a gas path through the engine and exit with the exhaust gases, at least a portion of these particles may stick to certain components within the gas turbine engine's gas path, potentially changing aerodynamic and/or thermal properties of the engine, reducing engine performance, or even reducing engine life.

In order to remove such foreign particles from within the gas path of the gas turbine engine, a cleaning operation can be performed that directs water or other fluids towards an inlet of the gas turbine engine. However, such cleaning operations may require elongated soaking times or multiple cycles in order to sufficiently remove such foreign particles.

Accordingly, systems and methods for cleaning gas turbine engines that reduces cleaning time would be desirable in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a schematic cross-sectional view of a gas turbine engine in accordance with an exemplary aspect of the present disclosure.

FIG. 2 illustrates a schematic view of an exemplary cleaning system for cleaning gas turbine engines in accordance with an exemplary aspect of the present disclosure.

FIG. 3 illustrates example organic abrasive particles for cleaning gas turbine engines in accordance with an exemplary aspect of the present disclosure.

FIG. 4 illustrates a schematic view of a computing system for cleaning gas turbine engines in accordance with an exemplary aspect of the present disclosure.

FIG. 5 illustrates a flow diagram of one embodiment of a cleaning control algorithm for cleaning gas turbine engines in accordance with an exemplary aspect of the present disclosure.

FIG. 6 illustrates a flow diagram of one embodiment of a method for cleaning gas turbine engines in accordance with an exemplary aspect of the present disclosure.

Repeat use of reference characters in the present specification and drawings is intended to represent the same or analogous features or elements of the present technology.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a,” “an,” and “the” include plural references unless the context clearly dictates otherwise.

The term “at least one of” in the context of, e.g., “at least one of A, B, and C” refers to only A, only B, only C, or any combination of A, B, and C.

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The terms “forward” and “aft” refer to relative positions within a gas turbine engine or vehicle, and are based on a normal operational attitude of the gas turbine engine or vehicle. More particularly, forward and aft are used herein with reference to a direction of travel of the vehicle and a direction of propulsive thrust of the gas turbine engine.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “first,” “second,” and “third” may be used interchangeably to distinguish one component from another and are not intended to signify location or importance of the individual components.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

The present disclosure is generally related to gas turbine engines and, more particularly, to a system and related method for cleaning gas turbine engines. For instance, the present subject matter is directed to introducing organic particles during cleaning of a gas turbine engine, where the organic particles act as an abrasive that helps to loosen and remove built up foreign particles within the gas turbine engine. The organic particles may be used in one or more cleaning phases to increase cleaning efficacy while reducing cleaning times. Additionally, by using organic particles, additional cleaning measures may not be necessary to remove residual organic particles at the end of cleaning.

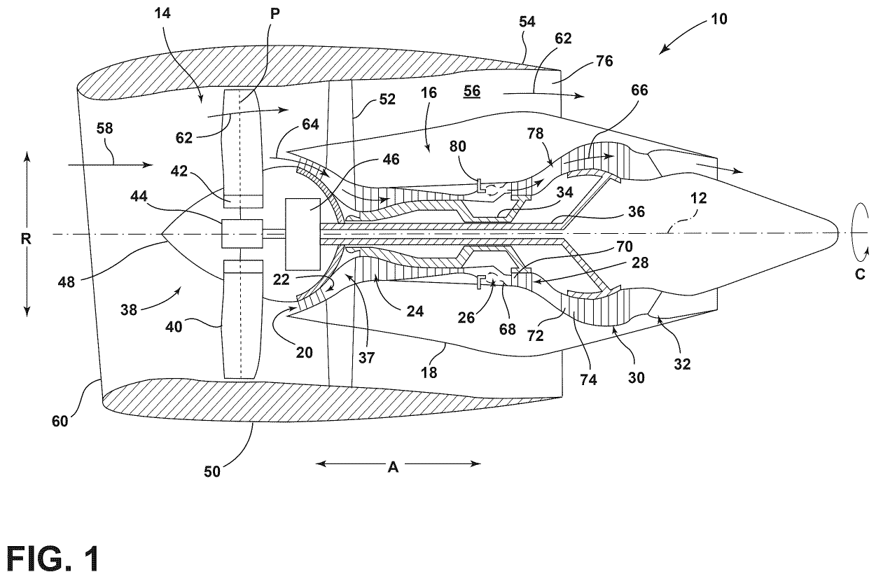

Referring now to the drawings, wherein identical numerals indicate the same elements throughout the figures, FIG. 1 illustrates a schematic cross-sectional view of a gas turbine engine 10 in accordance with an exemplary embodiment of the present disclosure. More particularly, for the embodiment of FIG. 1, the gas turbine engine 10 is a high-bypass turbofan jet engine, sometimes also referred to as a “turbofan engine.” As shown in FIG. 1, the gas turbine engine 10 defines an axial direction A (extending parallel to a longitudinal centerline 12 provided for reference), a radial direction R (extending perpendicular to the longitudinal centerline 12), and a circumferential direction C extending about the longitudinal centerline 12. In general, the gas turbine engine 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft 34 (which may additionally or alternatively be a spool) drivingly connects the HP turbine 28 to the HP compressor 24. A low pressure (LP) shaft 36 (which may additionally or alternatively be a spool) drivingly connects the LP turbine 30 to the LP compressor 22. The compressor section, combustion section 26, turbine section, and jet exhaust nozzle section 32 together define a core gas flow path 37.

For the embodiment depicted, the fan section 14 includes a fan 38 having a plurality of fan blades 40 coupled to a disk 42 in a circumferentially spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 may further include (such as in a geared turbofan) a power gear box 46, and the fan blades 40, disk 42, and pitch change mechanism 44 are together rotatable about the longitudinal centerline 12 by the LP shaft 36 across the power gear box 46. The power gear box 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by rotatable front hub 48 of the fan section 14 (sometimes also referred to as a “spinner”). The front hub 48 is aerodynamically contoured to promote an airflow through the plurality of fan blades 40.

Additionally, the exemplary fan section 14 includes an annular fan casing or outer nacelle 50 that circumferentially surrounds the fan 38 and/or at least a portion of the turbomachine 16. It should be appreciated that the nacelle 50 is supported relative to the turbomachine 16 by a plurality of circumferentially-spaced outlet guide vanes 52 in the embodiment depicted. Moreover, a downstream section 54 of the nacelle 50 extends over an outer portion of the turbomachine 16 so as to define a bypass airflow passage 56 therebetween.

During operation of the gas turbine engine 10, a volume of air (e.g., as indicated by arrow 58) enters the gas turbine engine 10 through an associated inlet 60 of the nacelle 50 and fan section 14. As the volume of air 58 passes across the fan blades 40, a first portion of the air (e.g., as indicated by arrow 62) is directed or routed into the bypass airflow passage 56 and a second portion of the air (e.g., as indicated by arrow 64) is directed or routed into the core gas flow path 37, or more specifically into the LP compressor 22. The ratio between the first portion of air 62 and the second portion of air 64 is commonly known as a bypass ratio. A pressure of the second portion of air 64 is increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, thereby supporting operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the gas turbine engine 10, also providing propulsive thrust. The HP turbine 28, the LP turbine 30, and the jet exhaust nozzle section 32 at least partially define a hot gas path 78 for routing the combustion gases 66 through the turbomachine 16.

It should be appreciated, however, that the exemplary gas turbine engine 10 depicted in FIG. 1 is by way of example only, and that in other exemplary embodiments, the gas turbine engine 10 may have any other suitable configuration. For example, although the gas turbine engine 10 depicted is configured as a ducted gas turbine engine (i.e., including the outer nacelle 50), in other embodiments, the gas turbine engine 10 may be an unducted gas turbine engine (such that the fan 38 is an unducted fan, and the outlet guide vanes 52 are cantilevered from the outer casing 18). Additionally, or alternatively, although the gas turbine engine 10 depicted is configured as a geared gas turbine engine (i.e., including the power gear box 46) and a variable pitch gas turbine engine (i.e., including a fan 38 configured as a variable pitch fan), in other embodiments, the gas turbine engine 10 may additionally or alternatively be configured as a direct drive gas turbine engine (such that the LP shaft 36 rotates at the same speed as the fan 38), as a fixed pitch gas turbine engine (such that the fan 38 includes fan blades 40 that are not rotatable about a pitch axis P), or both. It should also be appreciated, that in still other exemplary embodiments, aspects of the present disclosure may be incorporated into any other suitable gas turbine engine. For example, in other exemplary embodiments, aspects of the present disclosure may (as appropriate) be incorporated into, e.g., a turboprop gas turbine engine, a turboshaft gas turbine engine, or a turbojet gas turbine engine.

In general, as indicated above, the volume of air 58 entering the gas turbine engine 10 through the associated inlet 60 of the nacelle 50 and the fan section 14 may contain foreign particles. While a majority of the foreign particles will follow the hot gas path 78 through the engine and exit with the exhaust gases or through the bypass airflow passage 56, at least a portion of these foreign particles may stick to certain components within the gas turbine engine 10, such as in the hot gas path 78 and/or the airflow passage 56, potentially changing aerodynamic and/or thermal properties of the engine, reducing engine performance, or even reducing engine life.

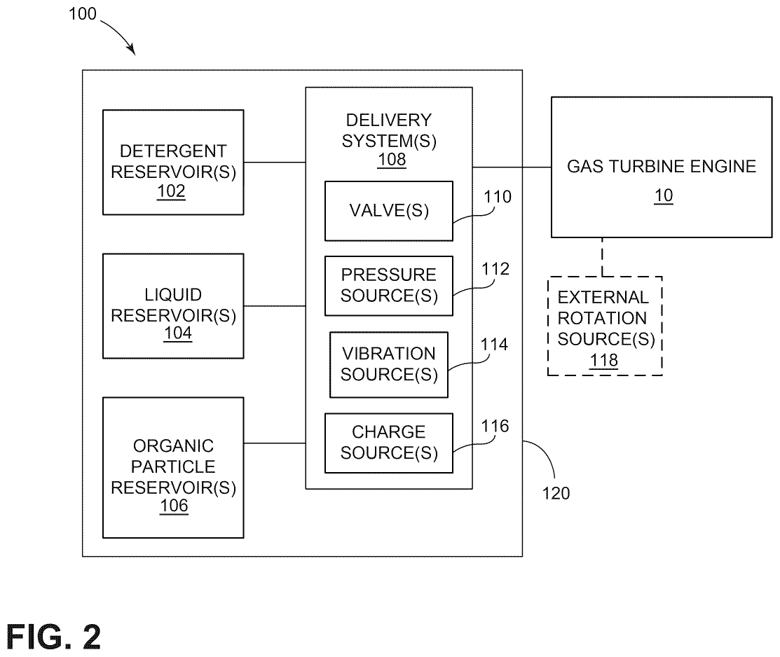

As such, referring now to FIG. 2, a schematic view of an exemplary cleaning system 100 for cleaning gas turbine engines is illustrated in accordance with an exemplary aspect of the present disclosure. It should be appreciated that, while the cleaning system 100 will be described with reference to the gas turbine engine 10 of FIG. 1, the cleaning system 100 may be suitable for use with any other suitable gas turbine engine.

In general, the cleaning system 100 is configured to remove foreign particles from gas turbine engines, such as the gas turbine engine 10, or components thereof. For instance, the cleaning system 100 may include one or more cleaning mediums. For example, the cleaning system 100 may include: one or more detergent reservoirs 102, where each of the detergent reservoirs 102 is configured to hold a detergent cleaning medium; one or more liquid reservoirs 104, where each of the liquid reservoirs 104 is configured to hold a liquid cleaning medium; and/or one or more organic particle reservoirs 106, where each of the organic particle reservoirs 106 is configured to hold an organic particle cleaning medium. In some instances, for example, each detergent cleaning medium may be a soap detergent that may be processed to become a foamed cleaning medium. In one or more instances, for example, the liquid cleaning medium may be water, such as distilled water and/or de-ionized water. As will be described below in greater detail, each organic particle cleaning medium may include one or more organic particles configured to act as an abrasive cleaning medium. In some instances, the reservoir(s) 102, 104, 106 may be configured to hold a mixture of different cleaning mediums.

The system 100 may further include one or more delivery systems 108 having any suitable delivery devices for delivering the cleaning medium(s) to the gas turbine engine 10 in-situ, or components thereof. For instance, for delivering cleaning medium(s) in-situ, the delivery systems 108 may inject the cleaning medium(s) at one or more location(s) of the gas turbine engine 10, such as at a gas turbine inlet (e.g., at the inlet 20, the inlet 60, an inlet at the combustion section 26, and/or the like), at one or more borescope ports of the gas turbine engine 10 (e.g., at one or more borescope ports of the compressor section, one or more borescope ports of the combustion section 26, and/or the like), at an existing baffle plate of the gas turbine engine 10, and/or any other suitable location. The delivery system(s) 108 may include, without limitation, one or more valves 110 selectively adjustable to direct cleaning medium(s) through associated pipes, hose, conduits, tubing, or similar to the appropriate location(s) of the gas turbine engine 10, or components thereof. For instance, the valve(s) 110 may be adjustable to selectively supply detergent cleaning medium from the detergent reservoir(s) 102 alone, liquid cleaning medium from the liquid reservoir(s) 104 alone, organic particle cleaning medium from the organic particle reservoir(s) 106 alone, or any suitable combinations thereof, as will be described in greater detail below.

The delivery system(s) 108 may include one or more pressure sources 112, such as one or more fans, one or more blowers, one or more pumps, and/or the like, for directing the cleaning medium(s) through the associated pipes, hose, conduits, tubing, and/or the like to the gas turbine engine 10, or components thereof. The pressure source(s) 112 may pressurize the cleaning medium(s) for delivery. For instance, the detergent cleaning medium may be processed by the delivery system(s) 108 to form a foamed cleaning medium for delivery. For example, the delivery system(s) 108 may be configured to control the valve(s) 110 and the pressure source(s) 112 to mix the detergent cleaning medium from the detergent reservoir(s) 102 with gas, such as air and/or inert gas, to generate a foamed detergent cleaning medium. As another example, the delivery system(s) 108 may be configured to control the valve(s) 110 and the pressure source(s) 112 to distribute organic particle cleaning medium from the organic particle reservoir(s) 106 in air at a particular flow rate.

In some instances, the delivery system(s) 108 may include one or more vibration sources 114 configured to generate vibrations. The vibration source(s) 114 may help to improve distribution of the cleaning medium(s). For instance, applying vibration via the vibration source(s) 114 when mixing the cleaning medium(s) (e.g., with each other, with air, and/or the like) may help more evenly distribute the cleaning medium(s). For example, in some embodiments, vibrations may be applied via the vibration source(s) 114 as the organic particle cleaning medium(s) within the organic particle reservoir(s) 106 is being dispensed, where the applied vibrations help overcome attractive forces between the organic particles of the organic particle cleaning medium(s). As such, clumps of organic particles may be separated for more even distribution, for instance, when being distributed in air or another cleaning medium (e.g., liquid cleaning medium and/or detergent cleaning medium). In such instances, the vibration source(s) 114 may be configured to apply vibrations to the organic particle reservoir(s) 106 and/or to conduits extending therefrom. In one instance, the vibrations are applied to the organic particle cleaning medium(s) before mixing (e.g., with air and/or other cleaning medium(s)).

In some instances, vibrations may be applied at or just prior to entry of the cleaning medium(s) into the gas turbine engine 10, or application to parts of the gas turbine engine 10. If the cleaning medium(s) used includes foamed cleaning medium(s) (e.g., foamed detergent cleaning medium with or without organic particle cleaning medium), the vibrations would vibrate the foam bubbles. In an instance where vibrations of high enough frequencies are applied to foamed cleaning medium(s), the bubbles of air within the foamed cleaning medium(s) may implode, which may cause micro-cavitation that improves removal of residues within the gas turbine engine 10, or on components thereof, where the micro-cavitation occurs. Generally, more dense foams may be able to withstand higher frequencies than less dense foams before bubbles begin imploding.

The vibration source(s) 114 may be any suitable vibration generation device(s) configured to generate vibrations at any other suitable frequency or frequency range and at any suitable amplitude or amplitude range that provides suitable mixing and/or cleaning effects. For example, in some embodiments, the vibration source(s) 114 may include one or more ultrasonic transducers (e.g., piezoelectric transducer(s)) configured to generate vibrations at ultrasonic frequencies (e.g., 20 kilohertz (kHz) or higher, such as between 20 kHz and 40 kHz). However, in some instances, the vibration source(s) 114 may be configured to generate vibrations at other frequencies, such as from 1 KHz to 40 KHz.

In some instances, the delivery system(s) 108 may include one or more charge source(s) 116. In general, when the cleaning medium(s) have an electrical charge that is opposite to an electrical charge of the residue being removed, the cleaning medium(s) may attract to the residue and help carry the residue out of the gas turbine engine 10, or off components thereof. For instance, if the residue being removed (e.g., fine dust particles) is positively charged, the cleaning medium(s) may be negatively charged, or vice versa. The charge source(s) 116 may be any suitable device or medium suitable configured to electrostatically charge the cleaning medium(s). For instance, in one embodiment, the charge source(s) 116 may include one or more friction-based charge devices, one or more induction-based charge devices, one or more conduction-based charge devices, one or more electrostatic coating-based charge devices (e.g., to coat the organic particles in a charged coating), and/or the like or combinations of the above mentioned devices. In one or more instances, the liquid cleaning medium and/or the detergent cleaning medium (e.g., foamed detergent) may be charged. In some instances, the organic particles of the organic particle cleaning medium may be charged. In such an instance, it may be beneficial to dispense the charged organic particles with or after applying a light mist (e.g., droplet size of less than 5 micrometers (μm)) to the gas turbine engine 10, or component(s) thereof, to prevent attraction between the charged organic particles and the gas turbine engine 10 itself, or component(s) thereof, when the gas turbine engine 10 or component(s) thereof are metallic and grounded. The gas turbine engine 10, or components thereof, may be electrically isolated from the ground by, for example, positioning an aircraft or other device having the gas turbine engine 10 on an electrically insulating mat(s), and/or by placing the components removed from the gas turbine engine 10 for cleaning on an electrically insulating mat(s).

In one or more instances, the charge source(s) 116 may be controlled to apply an electrostatic charge to the gas turbine engine 10, or components thereof, being cleaned. For instance, by applying an electrostatic charge to the gas turbine engine 10, or components thereof, while the gas turbine engine 10, or components thereof, is electrically isolated from the ground, the particles to be removed from the gas turbine engine 10 may similarly be charged. In some instances, the organic cleaning medium(s) may be subsequently supplied to the gas turbine engine 10, or components thereof, with the same electrostatic charge as the gas turbine engine 10, or components thereof, and thus, the same electrostatic charge as the particles to be removed. As such, the organic cleaning medium(s) may be repelled from the engine surfaces during dispensing. After dispensing the organic cleaning medium(s), the charge source(s) 116 may be controlled to reverse the charge on the gas turbine engine 10, or components thereof, being cleaned, such that the organic cleaning medium(s) is then attracted to the gas turbine engine 10, or components thereof, being cleaned with improved adhesion for removing large particles and/or harder debris layers in addition to fine dust particles.

In some instances, one or more components of the gas turbine engine 10 may be configured to be rotated during cleaning. In such instances, one or more external rotation source(s) 118 may be configured to be rotatably coupled (directly or indirectly) to one or more components of the gas turbine engine 10 (e.g., the HP shaft 34, the LP shaft 36, and/or the like) to rotate components of the gas turbine engine 10 during cleaning. In one instance, the external rotation sources(s) 118 may rotate the components of the gas turbine engine 10 within a cleaning speed range (e.g., between 2 revolutions per minute (rpm) and 500 rpm), which is lower than an operating speed range (e.g., above 1000 rpm, such as several thousand rpm) for operation of the gas turbine engine 10. The external rotation source(s) 118 may be any suitable external rotation device or combination of devices, such as an external motor(s), a blower(s), an air puller mechanism(s), and/or the like, not present for full operation of the gas turbine engine 10.

It should be appreciated that the various components of the cleaning system 100 (e.g., the valve(s) 110, the pressure source(s) 112, the vibration source(s) 114, the charge source(s) 116, the external rotation source(s) 118, and/or the like) may be manually controlled, automatically controlled, or a combination thereof. It should also be appreciated that various components of the cleaning system 100 may be supported on a wash cart 120. The wash cart 120 may have a plurality of wheels (not shown), a handle (not shown), a motor (not shown), and/or the like to allow the wash cart 120 to be moved to a desired location, such as proximate to the gas turbine engine 10. The wash cart 120 may be modular to allow the different components stored thereon to be easily removable/replaceable or interchangeable.

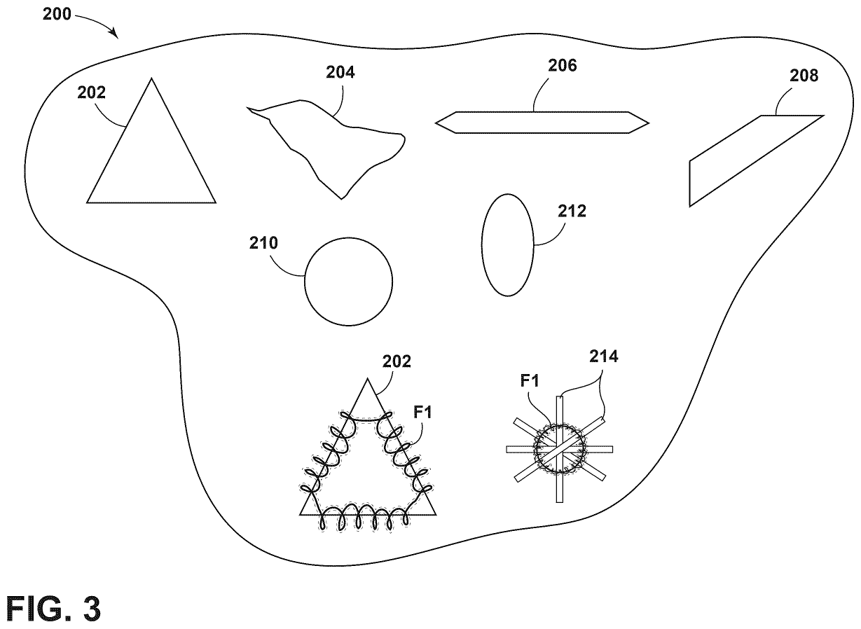

In accordance with particular aspects of the present disclosure, FIG. 3 illustrates example organic abrasive particles that may be used in organic particle cleaning medium(s) 200 for cleaning gas turbine engines, such as the gas turbine engine 10. In general, by using organic abrasive particles in cleaning mediums for cleaning gas turbine engines, any remaining organic particles can be safely burned off during the first operation of the gas turbine engines after cleaning without causing damage to components of the gas turbine engines or leaving organic residues. As such, no additional cleaning is needed after use of the organic abrasive particles.

The shape and size of the organic particles may be selected to provide particular cleaning characteristics. For instance, in some instances, the organic particle cleaning medium(s) 200 includes organic particles of one or multiple initial shapes. In some instances, the shape(s) of the organic particles initially includes multiple sharp corners or edges which may impact and scratch hard layers of residue being removed, which may help remove the residue. For example, as shown in FIG. 3, different example initial shapes of organic particles that may be present in the organic particle cleaning medium(s) 200 are shown for reference. More particularly, the organic particle cleaning medium(s) 200 shown in FIG. 3 includes a first organic particle 202 that is triangular in shape; a second organic particle 204 that is irregularly shaped, with multiple corners; a third organic particle 206 that is lath shaped (e.g., long, narrow, with multiple corners at the ends); and a fourth organic particle 208 that is trapezoidal in shape. When the organic particles 202, 204, 206, 208 impact components of the gas turbine engine 10, the organic particles 202, 204, 206, 208 may break down into smaller particle pieces, which may result in even more corners and edges. In some instances, the organic particles may not have any initial sharp corners and/or sharp edges. For instance, as shown in FIG. 3, the organic particle cleaning medium(s) 200 includes a fifth organic particle 210 that is circular in shape; and a sixth organic particle 212 that is oval in shape. While the organic particles 210, 212 may not have any initial sharp corners and/or edges, when the organic particles 210, 212 impact components of the gas turbine engine 10, the organic particles 210, 212 may break down into smaller particle pieces, which may have sharp corners and/or edges, and therefore help to remove residue.

It should be appreciated that while the shapes of the organic particles that may be present in the organic particle cleaning medium(s) 200 are shown in two dimensions, it should be appreciated that organic particles may have similar shaping in three dimensions or may be flat. For example, the first organic particle(s) 202 shown as being triangular in two dimensions may be part of a pyramidal structure or may be part of a triangular prism structure (flat) when viewed in three dimensions. As another example, the fifth organic particle(s) 210 are shown as being circular in two dimensions and may be spherical or a circular prism when viewed in three dimensions. It should further be appreciated that the examples provided herein are not exhaustive. Any suitable shape having any suitable number of corners or sharp edges for cleaning may be used. It should additionally be appreciated that a combination of the different shaped particles may be mixed together and used in the same flow of organic particle cleaning medium(s) 200, may be used separately in separate flows of organic particle cleaning medium(s) 200, or both.

In some instances, the organic particles present in the organic particle cleaning medium(s) 200 may be made of organic materials. For instance, the organic particles may be made of one or more readily dissolvable organic material(s) that are easily dissolved in liquid (e.g., water). The dissolvable organic materials may have a particular hardness when dry. The dissolvable organic material(s) may be easily shaped to provide particular initial shapes (e.g., the shapes of the organic particles 202, 204, 206, 208, 210, 212). For example, the dissolvable organic material(s) may be melted (e.g., under heat) and formed into the desired initial shapes (e.g., in molds). Examples of suitable dissolvable organic material(s) include sugar crystals, honey wax crystals, and/or the like. The dissolvable organic particles may have a hardness of about 2 Mohs to 3 Mohs (e.g., up to about 140 Vickers), such as about 2.5 Mohs.

In some instances, the organic particles present in the organic particle cleaning medium(s) 200 may be made of one or more relatively hard, organic materials that are not readily dissolvable in liquids (e.g., in water). For instance, the organic materials formed of organic materials that are not readily dissolvable may substantially retain their shape when dry or wet. For example, organic materials that are not readily dissolvable include shells (e.g., coconut shells, walnut shells, almond shells, and/or the like), fruit pit stones (e.g., plum, peach, and/or the like), bamboo pieces, camphor (e.g., camphor wood, camphor wax, and/or a combination of camphor wood and camphor wax), and/or the like. The organic materials formed of organic materials that are not readily dissolvable may be shaped into the desired initial shapes in any suitable manner. For instance, it should be appreciated that camphor wax may act as a binder for camphor wood pieces to create a desired shape and/or size of the particles. Such not readily dissolvable organic particles will be referred to alternatively herein as “insoluble organic particles.” The insoluble organic particles may have a hardness of up to about 6 Mohs (e.g., about 750 Vickers), as hardness values above 6 Mohs may begin to cause surface damage (e.g., erosion) of parts of the gas turbine machine 10. For instance, the insoluble organic particles may have a hardness of about 3 Mohs to 5 Mohs (e.g., about 140 Vickers to about 540 Vickers), such as about 3 Mohs to 4 Mohs (e.g., about 140 Vickers to about 210 Vickers), such as about 3.5 Mohs. In some instances, the hardness of the insoluble organic particles may be harder than the hardness of the dissolvable organic particles. For instance, in some embodiments, the hardness of the insoluble organic particles is about 1.5 times to about 3 times the hardness of the dissolvable organic particles.

As used herein, the organic particles of the present in the organic particle cleaning medium(s) 200 may be “microparticles.” More particularly, in some instances the organic particles may have a particle dimension (e.g., largest length dimension) that is less than about 100 μm, such as between about 10 μm and about 100 μm, such as from about 10 μm to about 40 μm. In general, the momentum of organic particles having a largest dimension that is smaller than 10 μm may not be sufficient to effectively remove residue in the gas turbine engine 10 and could potentially accumulate within particular cooling circuits. Further, organic particles having a largest dimension that is larger than 100 μm may not have sufficient velocity to effectively remove residue in the gas turbine engine 10 and could potentially accumulate within particular cooling circuits.

In some instances, the organic particles of the present in the organic particle cleaning medium(s) 200 may have varying particle sizes. For example, in certain embodiments, the abrasive microparticles present in a flow of the organic particle cleaning medium(s) 200 may include both a first set of microparticles having a median or average particle diameter within a first, smaller range and a second set of microparticles having a median particle diameter within a second, larger range. Suitable ranges, including the first and second ranges, each generally encompass a particle diameter size range that is still less than 100 μm. For example, in certain embodiments, the first set of microparticles may have a median particle diameter equal to or less than 20 μm, whereas the second set of microparticles may have a median particle diameter equal to or greater than 20 μm. More specifically, the first range may be equal to or less than 10 μm, whereas the second range may be equal to or greater than 30 μm, or more preferably equal to or greater than 40 μm. Thus, a median of the second range may be larger than a median or average of the first range. Such mixture may provide particles of different flow characteristics within the same flow, which may increase the cleaning efficiency of such flow.

In some instances, at least some of the organic particles present in the organic particle cleaning medium(s) 200 may have fibers F1 to improve cleaning efficiency. For example, as shown in FIG. 3, one of the first organic particles 202 present in the organic particle cleaning medium(s) 200 is shown as having fibers F1. The fibers F1 themselves may be abrasive and/or may increase the abrasiveness of the organic particles. In some instances, the fibers F1 may help to break up clumps of organic particles for distribution, as the fibers F1 may help create more air space between the particles. Moreover, the fibers F1 may increase the surface area of the organic particles for collecting and removing loosened residue. In some instances, the fibers F1 are used to bind together multiple organic particles in the organic particle cleaning medium(s) 200 to improve the abrasiveness of the organic particles. For instance, as shown in FIG. 3, multiple organic particles 214 (e.g., rectangular shaped organic particles) are bound together by the fibers F1. As such, the shape of the bound together organic particles may be more abrasive than the individual organic particles, which improves the cleaning efficiency of the organic particles.

The fibers F1 may be part of the organic particles in any suitable matter. The fibers F1 may include fibers that are an integral part of the organic materials that make up the organic particles or may additionally, or alternatively, include fibers that are added to the base material of the organic particles. For example, when the organic particle is made of coconut shell, the fibers F1 may be the coconut fiber of the shell. As another example, the fibers F1 may be coconut fibers, kapok fibers, cotton fibers, and/or the like which are separate from the base organic material(s) used for the organic particles and added (e.g., wound around, adhered to, coated with, woven around, and/or the like) to the base organic material(s) used for the organic particles. It should be appreciated that fibers F1 may be used on dissolvable or insoluble base materials. For instance, particles with fibers may be wound or otherwise applied to large dissolvable base material(s) such that, when the base material(s) dissolves, a woven matrix of fibers would be left behind, which could act as movable traps for non-detached dirt particles.

It should be appreciated that the type of fiber used may have particular properties that may be helpful in certain cleaning conditions. For instance, coconut fibers may be particularly abrasive to help with mechanical cleaning in areas with harder build up. As another example, kapok fiber is an example of a hydrophobic and oleophilic fiber that absorbs oil and repels water. Kapok fiber has a hollow structure that makes it particularly oleophilic compared to other fibers of similar dimensions. Cotton and kapok fibers, or blends with such fibers, may be used to make oil sorbents. During cleaning, if oil traces are observed, then the oil sorbents having cotton and/or kapok fibers may be used to capture oil from water.

Additionally, the fibers F1 of the organic particles present in the organic particle cleaning medium(s) 200 may be electrostatically charged to improve the cleaning efficiency of the organic particles. For instance, the fibers F1 may be used to more easily induce electrostatic charge on the organic particles present in the organic particle cleaning medium(s) 200. However, it should be appreciated that, in some instances, the organic particles present in the organic particle cleaning medium(s) 200 may be electrostatically charged without the presence of fibers F1. In some instances, the fibers F1 are coated with a charged coating (e.g., ionogel) that is conductive and/or more susceptible to carrying charge.

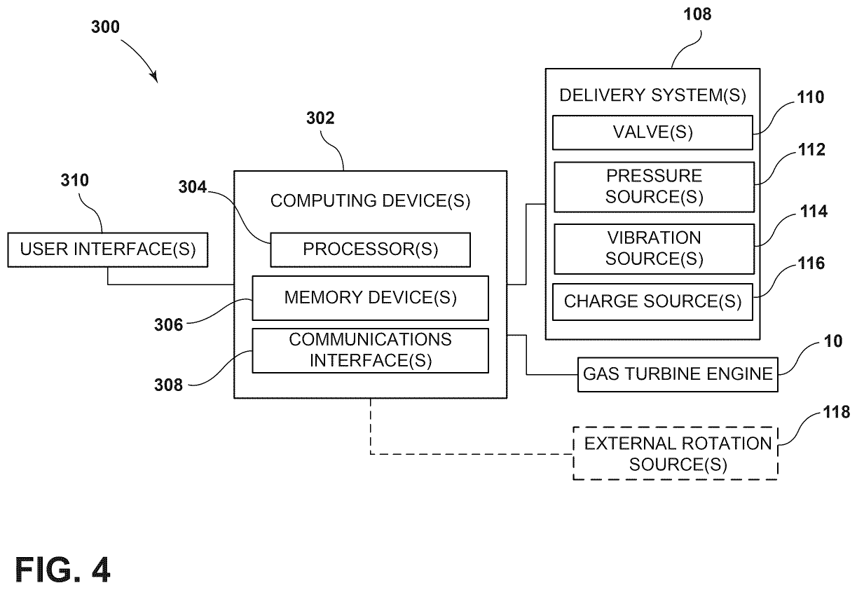

Referring now to FIG. 4, a schematic view of a computing system 300 for cleaning gas turbine engines is illustrated in accordance with an exemplary aspect of the present disclosure. In general, the computing system 300 will be described with reference to the gas turbine engine 10 described with reference to FIG. 1, and the cleaning system 100 described with reference to FIGS. 2 and 3. However, it should be appreciated that the disclosed computing system 300 may be implemented with gas turbine engines and cleaning systems having any other suitable configurations.

In several embodiments, the computing system 300 may include one or more computing devices 302 and various other components configured to be communicatively coupled to and/or controlled by the computing device(s) 302. For instance, the computing system 300 may include one or more components of the cleaning system 100, such as the one or more components of the delivery system(s) 108 (e.g., the valve(s) 110, the pressure source(s) 112, the vibration source(s) 114, the charge source(s) 116, and/or the like), the external rotation source(s) 118, one or more components of the gas turbine engine 10, one or more user interface(s) 310, and/or the like. It should be appreciated that the user interface(s) 310 described herein may include, without limitation, any combination of input and/or output devices that allow an operator to provide inputs to the computing device(s) 302 and/or that allow the computing device(s) 302 to provide feedback to the operator, such as a keyboard, keypad, pointing device, buttons, knobs, touch sensitive screen, mobile device, audio input device, audio output device, and/or the like.

In general, the computing device(s) 302 may correspond to any suitable processor-based device(s), such as a computing device or any combination of computing devices. Thus, as shown in FIG. 4, the computing device(s) 302 may generally include one or more processors 304 and one or more associated memory devices 306 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 306 may generally have memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 306 may generally be configured to store information accessible to the processor(s) 304, including data that can be retrieved, manipulated, created and/or stored by the processor(s) 304 and instructions that can be executed by the processor(s) 304.

The computing device(s) 302 may also include a communications interface 308 to provide a means for the computing device(s) 302 to communicate with any of the various system components described herein. For instance, one or more communicative links or interfaces (e.g., one or more data buses) may be provided between the communications interface 308 and any system components configured to carry out one or more of the elements of the disclosed method. For example, as illustrated, the computing device(s) 302 may be communicatively coupled via one or more communicative links or interface(s) to the delivery system(s) 108 (and/or individual components thereof), one or more components of the gas turbine engine 10, the external rotation source(s) 118, the user interface(s) 310, and/or the like.

It should be appreciated that in some instances, the computing device(s) 302 is a separate computing device communicatively coupled to an existing computing device for controlling the gas turbine engine 10 during normal operation. However, in some instances, the computing device(s) 302 is part of the existing computing device for controlling the gas turbine engine 10 during normal operation and configured to perform one or more of the functions described herein for cleaning operations.

In general, the instructions stored within the memory device(s) 306 of the computing device(s) 302 may be executed by the processor(s) 304 to implement a cleaning operation for cleaning gas turbine engines, such as the gas turbine engine 10. The computing device(s) 302 may generally control (directly or indirectly) the components of the delivery system(s) 108 to direct cleaning medium from one or more of the reservoirs 102, 104, 106 (FIG. 2) to the gas turbine engine 10, or parts thereof, for performing the cleaning. In some instances, the computing device(s) 302 may be configured to automatically control the various components of the computing system 300 to perform a cleaning operation, such as in response to receiving an input indicative of a request to begin the cleaning process. However, in some instances, an operator may manually control various components of the computing system 300 to perform a cleaning operation.

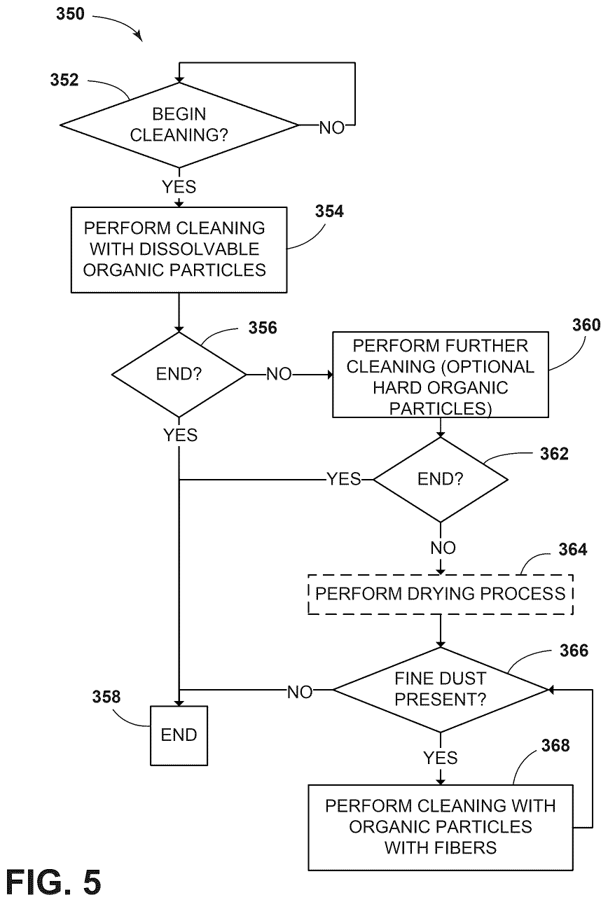

Referring now to FIG. 5, FIG. 5 illustrates a flow diagram of one embodiment of a cleaning control algorithm 350 for cleaning gas turbine engines in accordance with an exemplary aspect of the present disclosure. In general, while some parts of the cleaning control algorithm 350 will be described herein as being implemented by the computing device(s) 302 of the computing system 300 described above with reference to FIG. 4, it should be appreciated that the various processes described below may alternatively be implemented by another computing device or any combination of computing devices. In addition, although FIG. 5 depicts control steps or functions performed in a particular order for purposes of illustration, the steps or functions of the cleaning control algorithm 350 discussed herein are not limited to any particular order or arrangement. One skilled in the art, using the disclosures provided herein, will appreciate that the various steps or functions of the cleaning control algorithm 350 disclosed herein can be omitted, rearranged, combined, and/or adapted in various ways without deviating from the scope of the present disclosure.

Particularly, as shown in FIG. 5, the cleaning control algorithm 350 may include determining at (352) whether cleaning of a gas turbine engine, or part thereof, is to begin. For instance, the computing device(s) 302 may be configured to receive an input indicative of a request to begin cleaning the gas turbine engine 10. For example, the computing device(s) 302 may receive an input via the user interface(s) 310 indicative of a request to begin the cleaning process for the gas turbine engine 10. In some instances, the input may simply command that the cleaning process begin. In some instances, the input may indicate the degree of buildup at one or more locations of the gas turbine engine 10 and/or components thereof. For example, in some instances, the input may indicate a measured thickness and the location of the buildup, the operating time and/or operating conditions since the last cleaning operation, and/or the like. In some instances, the input may include a series of pictures, where the images may be analyzed by the computing device(s) 302 (e.g., by comparing the pictures to corresponding pictures of the clean gas turbine engine 10, or parts thereof) to determine the degree(s) and/or location(s) of buildup. In one or more instances, the input may indicate that the delivery system 108 is turned on, that one or more components of the delivery system 108 is attached to the gas turbine engine 10 (or parts thereof), that the gas turbine engine 10 is being rotated at a cleaning speed, and/or the like. In some instances, the input may be received, at least in part, from the gas turbine engine 10 (e.g., from a computing system of the gas turbine engine 10).

Once it is determined at (352) that cleaning should begin, the cleaning control algorithm 350 may proceed to performing, at (354), cleaning with dissolvable organic particles. In some instances, an input indicative of a request to perform cleaning with dissolvable organic particles is received. For instance, the input indicative of the request to perform cleaning with dissolvable organic particles may be part of or may be the same request received at step (352) to begin cleaning. In some instances, the input indicative of the request is received from an operator via the user interface(s) 310. Similar as to described above, the input may simply command that cleaning with the dissolvable organic particles start. In some instances, the input may additionally, or alternatively, indirectly indicate that cleaning with dissolvable organic particles should begin. For instance, the input may indicate the degree of buildup at one or more locations of the gas turbine engine 10 and/or components thereof, which is correlated with requiring cleaning with dissolvable organic particles. For example, in some instances, the input may indicate a measured thickness and the location of the buildup, the operating time and/or operating conditions since the last cleaning operation, and/or the like, where such input is correlated with needing to clean with dissolvable organic particles. In some instances, the input may include a series of pictures, where the images may be analyzed by the computing device(s) 302 (e.g., by comparing the pictures to corresponding pictures of the clean gas turbine engine 10, or parts thereof) to determine the degree(s) and/or location(s) of buildup and to determine that cleaning with dissolvable organic particles is needed.

To perform cleaning with dissolvable organic particles, the delivery system 108 is controlled to direct dissolvable particles (e.g., made of sugar crystals, honey crystals, and/or the like without fibers F1) from the organic particle reservoir(s) 106 in a gas distribution medium (e.g., air) to the gas turbine engine 10, or parts thereof. In some instances, the cleaning with dissolvable organic particles takes place when the gas turbine engine 10, or part thereof, being cleaned is dry, or sufficiently dry, such that the dissolvable organic particles do not come into contact with wet areas of the gas turbine engine 10, or part thereof, and dissolve upon impact. The shape(s), size(s), and/or material(s) of the dissolvable organic particles used at (354) may be selected in any suitable manner. For instance, in one embodiment, an operator may select via the user interface(s) 310 the appropriate shape(s), size(s), and/or material(s) of the dissolvable organic particles and/or the shape(s), size(s), and/or material(s) of the dissolvable organic particles may be loaded into the organic particle reservoir(s) 106. For instance, the type of deposits observed could be used to determine which shape(s), size(s), and/or material(s) of the dissolvable organic particles to use. For example, the types of deposits could be related to simple fouling, hardened dust deposits from severe operating environments (e.g., high dust ingress such as when operating in the desert areas), and/or the like. For hardened deposits, particles having a higher number of sharp edges would be selected. Similarly, as another example, if the dust thickness is high, particles having a higher number of sharp edges would be selected.

As described above, in some instances, dissolvable organic particles having different shapes are used simultaneously. In some instances, dissolvable organic particles of a first shape are used in a first time frame and/or first injection location, and dissolvable organic particles of a second shape are used in a second time frame and/or second injection location. The first time frame may only partially overlap the second time frame. The second injection location may be separate from the first injection location. The first shape may be different from the second shape. However, in some instances, only dissolvable organic particles having the same initial shape are used, such as to generate a more uniform flow of organic particles.

As similarly described above, in some instances, dissolvable organic particles having different average sizes are used simultaneously. In some instances, dissolvable organic particles of a first size range are used in a first time frame and/or first injection location, and dissolvable organic particles of a second size range are used in a second time frame and/or second injection location. The first time frame may only partially overlap the second time frame. The second injection location may be separate from the first injection location. The first size range may only partially overlap the second size range. However, in some instances, only dissolvable organic particles of the same average size range are used, such as to generate a more uniform flow of organic particles.

As additionally described above, in some instances, dissolvable organic particles of different materials are used simultaneously. In some instances, dissolvable organic particles of a first material are used in a first time frame and/or first injection location, and dissolvable organic particles of a second material are used in a second time frame and/or second injection location. The first time frame may only partially overlap the second time frame. The second injection location may be separate from the first injection location. The first material (e.g., sugar crystals) may be different than the second material (e.g., honey crystals). However, in some instances, only dissolvable organic particles formed of the same material are used, such as to generate a more uniform flow of organic particles.

Moreover, as described above, in some instances, the gas turbine engine 10 may be configured to rotate during the cleaning process. For instance, the computing device(s) 302 may be configured to control the operation of the external rotation source(s) 118 and/or the gas turbine engine 10 to rotate the gas turbine engine 10 within the cleaning speed range.

Additionally, in some instances, the vibration source(s) 114 may be controlled (e.g., by the computing device(s) 302) to apply vibrations to the dissolvable organic particles within the organic particle reservoir(s) 106 to help separate the dissolvable organic particles from each other for dispersion in the delivery medium (e.g., air).

At (356), the cleaning control algorithm 350 may include determining whether the cleaning process should end. For instance, in some embodiments, an input may be received after cleaning with the dissolvable organic particles is performed at (354), where the input is indicative of whether the gas turbine engine 10, or parts thereof, is now sufficiently clean. For example, an operator may provide such input via the user interface(s) 310. In some instances, the input may include pictures, as described above. In some instances, the input may be different from, part of, or may be the same as the request initial request to perform cleaning with dissolvable organic particles received at step (352), and/or may be different from, part of, or may be the same as the request to perform cleaning with dissolvable organic particles optionally received at (354). In some instances, the input includes a request to perform a different cleaning operation, which indicates that the cleaning process should not end.

In some instances, a rinse operation occurs before such determination. During such rinse operation, the computing device(s) 302 controls the delivery system 108 to direct fluid (e.g., fluid from liquid reservoir(s) 104) to the gas turbine engine 10, or parts thereof, such that dissolvable organic particles remaining in the gas turbine engine 10, or on parts thereof, are dissolved and removed to allow for improved visibility of the gas turbine engine 10, or on parts thereof, being cleaned. The rinse operation may similarly help remove any loosened build up to improve visibility. In some instances, the rinse operation is followed by a drying operation to allow for clearer visibility of the gas turbine engine 10, or on parts thereof, being cleaned. For instance, the drying operation may include rotating one or more parts of the gas turbine engine 10 (e.g., controlling the external rotation source(s) 118 to rotate the gas turbine engine 10), controlling the delivery system 108 to direct air through the gas turbine engine 10, or parts thereof, and/or the like.

If no more cleaning is determined to be necessary at (356), then the cleaning control algorithm 350 may proceed to (358) and the cleaning process may end. At the end of the cleaning process, the computing device(s) 302 may control the operation of the delivery system 108 to stop supplying cleaning medium to the gas turbine engine 10, or parts thereof, the external rotation source(s) 118 to stop rotating the gas turbine engine 10, and/or the user interface(s) 310 to indicate that the cleaning process is complete. However, if at (356), it is determined that the cleaning process should not end (e.g., that the gas turbine engine 10, or parts thereof, are not sufficiently clean), then the cleaning control algorithm 350 proceeds to (360).

At (360), the cleaning control algorithm 350 may include performing further cleaning. In some instances, an input indicative of a request to perform further cleaning is received. For instance, the input indicative of the request to perform further cleaning may be part of or may be the same request received at any of steps (352)-(356). In some instances, the input indicative of the request is received from an operator via the user interface(s) 310. Similar as to described above, the input may simply command that further cleaning should be started. In some instances, the input may additionally, or alternatively, indirectly indicate that the further cleaning should begin. For instance, the input may indicate the degree of buildup at one or more locations of the gas turbine engine 10 and/or components thereof, which is correlated with requiring further cleaning. For example, in some instances, the input may indicate a measured thickness and the location of the buildup, the operating time and/or operating conditions since the last cleaning operation, and/or the like, where such input is correlated with needing further cleaning. In some instances, the input may include a series of pictures, where the images may be analyzed by the computing device(s) 302 (e.g., by comparing the pictures to corresponding pictures of the clean gas turbine engine 10, or parts thereof) to determine the degree(s) and/or location(s) of buildup and to determine that further cleaning is needed.

In some instances, the further cleaning is a foam wash and/or a liquid wash cleaning process. To perform the further cleaning with foam wash, the computing device(s) 302 is configured to control the delivery system(s) 108 (e.g., the valve(s) 110 and the pressure source(s) 112) to mix the detergent cleaning medium(s) from the detergent reservoir(s) 102 with gas, such as air, to generate a foamed detergent cleaning medium(s), and direct the foamed detergent cleaning medium(s) to the gas turbine engine 10, or parts thereof, for cleaning. To perform the further cleaning with liquid wash, the computing device(s) 302 is configured to control the delivery system(s) 108 (e.g., the valve(s) 110 and the pressure source(s) 112) to direct the liquid cleaning medium(s) from the liquid reservoir(s) 104 to the gas turbine engine 10, or parts thereof, for cleaning.

In some instances, insoluble organic particles are provided with the foamed detergent cleaning medium(s) and/or the liquid cleaning medium(s) to improve the cleaning efficiency of the foam wash and/or the liquid wash cleaning process. For instance, as discussed above, the insoluble, organic particles may be shells (e.g., coconut shells, walnut shells, almond shells, and/or the like), fruit pit stones (e.g., plum, peach, and/or the like), bamboo pieces, camphor, and/or the like. The hard, not insoluble organic particles may or may not have fibers F1. The insoluble organic particles may be directed from the organic particle reservoir(s) 106 to mix with the foamed detergent cleaning medium(s) and/or the liquid cleaning medium(s) before reaching the gas turbine engine 10, or parts thereof. The shape(s), size(s), and/or material(s) of the insoluble organic particles used at (360) may be selected in any suitable manner. For instance, in one embodiment, an operator may select via the user interface(s) 310 the appropriate shape(s), size(s), and/or material(s) of the insoluble organic particles and/or the shape(s), size(s), and/or material(s) of the insoluble organic particles may be loaded into the organic particle reservoir(s) 106. The shape(s), size(s), and/or material(s) of the insoluble organic particles used may similarly be selected based on the types of deposits observed, and/or in any other suitable manner.

As described above, in some instances, insoluble organic particles having different shapes are used simultaneously. In some instances, insoluble organic particles of a first shape are used in a first time frame and/or first injection location, and insoluble organic particles of a second shape are used in a second time frame and/or second injection location. The first time frame may only partially overlap the second time frame. The second injection location may be separate from the first injection location. The first shape may be different from the second shape. However, in some instances, only insoluble organic particles having the same initial shape are used, such as to generate a more uniform flow of organic particles.

As similarly described above, in some instances, insoluble organic particles having different average sizes are used simultaneously. In some instances, dissolvable organic particles of a first size range are used in a first time frame and/or first injection location, and insoluble organic particles of a second size range are used in a second time frame and/or second injection location. The first time frame may only partially overlap the second time frame. The second injection location may be separate from the first injection location. The first size range may only partially overlap the second size range. However, in some instances, only insoluble organic particles having the same initial size range are used, such as to generate a more uniform flow of organic particles.

As additionally described above, in some instances, insoluble organic particles of different materials are used simultaneously. In some instances, insoluble organic particles of a first material are used in a first time frame and/or first injection location, and insoluble organic particles of a second material are used in a second time frame and/or second injection location. The first time frame may only partially overlap the second time frame. The second injection location may be separate from the first injection location. The first material (e.g., bamboo) is different than the second material (e.g., coconut shell). However, in some instances, only insoluble organic particles having the same base material are used, such as to generate a more uniform flow of organic particles.

In some instances, the foam cleaning medium and/or the liquid cleaning medium (and/or the optional insoluble organic particles) is electrostatically charged. In one or more instances, the computing device(s) 302 may control the charge source(s) 116 such that the foam cleaning medium and/or the liquid cleaning medium (and/or the optional insoluble organic particles) is electrostatically charged.

Additionally, in some instances, the vibration source(s) 114 may be controlled (e.g., by the computing device(s) 302) to apply vibrations to improve cleaning. For instance, the vibration source(s) 114 may be controlled (e.g., by the computing device(s) 302) to apply vibrations to the insoluble organic particles within the organic particle reservoir(s) 106 to help separate the insoluble organic particles from each other for dispersion in the delivery medium (e.g., air). The vibration source(s) 114 may additionally, or alternatively, be controlled (e.g., by the computing device(s) 302) to apply vibrations to the cleaning medium (e.g., foamed detergent cleaning medium(s) and/or the liquid cleaning medium(s)) having the insoluble organic particles, such as where the cleaning medium(s) at or just prior to entry of the cleaning medium(s) into the gas turbine engine 10, or application to parts of the gas turbine engine 10. In instances where the insoluble organic particles are used and have the same electrostatic charge, the insoluble organic particles may repel each other, and thus, may not require the vibration to be applied.

At (362), the cleaning control algorithm 350 may include determining whether the cleaning process should end. For instance, similar to (356), an input may be received after the further cleaning is performed at (360), where the input is indicative of whether the gas turbine engine 10, or parts thereof, is now sufficiently clean. In some instances, the input may be different from, part of, or may be the same as the request(s) received at step (352), (354), (356), and/or (360). In some instances, the input includes a request to perform a different cleaning operation, which indicates that the cleaning process should not end.

In some instances, a rinse operation occurs before such determination, similar to as described above. In such instances, the computing device(s) 302 controls the delivery system 108 to direct fluid (e.g., fluid from liquid reservoir(s) 104) to the gas turbine engine 10, or parts thereof, such that organic particles and/or loosened build up remaining in the gas turbine engine 10, or on parts thereof, is removed to allow for clear visibility of the gas turbine engine 10, or on parts thereof, being cleaned. In some instances, the rinse operation is followed by a drying operation to allow for clearer visibility of the gas turbine engine 10, or on parts thereof, being cleaned. For instance, the drying operation may include rotating one or more parts of the gas turbine engine 10 (e.g., controlling the external rotation source(s) 118 to rotate the gas turbine engine 10), controlling the delivery system 108 to direct air through the gas turbine engine 10, or parts thereof, and/or the like.

If no more cleaning is determined to be necessary at (362), then the cleaning control algorithm 350 may proceed to (358) and the cleaning process may end. However, if at (362), it is determined that the cleaning process should not end (e.g., that the gas turbine engine 10, or parts thereof, are not sufficiently clean), then the cleaning control algorithm 350 proceeds to (364).

At (364), the cleaning control algorithm 350 may include performing a drying operation. In some instances, the drying operation takes place at (364) if a drying operation did not occur after the most recent cleaning stage (e.g., at (362)) to allow for clearer visibility of the gas turbine engine 10, or on parts thereof, being cleaned. The drying operation may include rotating one or more parts of the gas turbine engine 10 (e.g., controlling the external rotation source(s) 118 to rotate the gas turbine engine 10), controlling the delivery system 108 to direct air through the gas turbine engine 10, or parts thereof, and/or the like.

At (366), the cleaning control algorithm 350 may include determining whether fine dust is present within the gas turbine engine 10, or on parts thereof, being cleaned. For instance, an input may be received (e.g., after the drying process) where the input is indicative of whether fine dust particles (e.g., average particle size of less than 10 μm) are present within the gas turbine engine 10, or on parts thereof, being cleaned. In some instances, the input is received from an operator via the user interface(s) 310. In some instances, the input is directly indicative of whether fine dust particles are present. However, in some instances, the input is additionally, or alternatively, indirectly indicative of whether fine dust particles are present. For instance, the input may include the operating time and/or operating conditions since the last cleaning operation, and/or the like, where such input is correlated with the likelihood of fine dust particles being present. In some instances, the input may include a series of pictures, where the images may be analyzed by the computing device(s) 302 (e.g., by comparing the pictures to corresponding pictures of the clean gas turbine engine 10, or parts thereof) to determine the degree(s) and/or location(s) of buildup and to determine the presence of fine dust particles. In some instances, the input may be different from, part of, or the same as the input received at another step (e.g., at (352), (354), (356), (360), (362), (364), and/or the like). It should be appreciated that a particular amount of fine dust or a particular surface area having fine dust coverage may need to be present to determine that fine dust is present.

If at (366), it is determined that fine dust is not present at the gas turbine engine 10, or on parts thereof, being cleaned, then the cleaning control algorithm 350 may proceed to (358) and end. However, if at (366), it is determined that fine dust is present at the gas turbine engine 10, or on parts thereof, being cleaned, then the cleaning process may proceed to (368).

At (368), the cleaning control algorithm 350 may include performing cleaning with organic particles having fibers. Particularly, organic particles having fibers, such as the fibers F1, may have more surface area for collecting fine dust particles (e.g., smaller than 10 μm). As such, to perform cleaning with organic particles having the fibers F1, the delivery system 108 is controlled to direct organic particles having the fibers F1 from the organic particle reservoir(s) 106 in a gas distribution medium (e.g., air) to the gas turbine engine 10, or parts thereof. The cleaning with organic particles having the fibers F1 takes place when the gas turbine engine 10, or part thereof, being cleaned is dry, or sufficiently dry, such that the organic particles do not come into contact with wet areas of the gas turbine engine 10, or part thereof. If the fibers F1 of the organic particles become too wet, which could reduce their cleaning efficiency. For instance, if the fibers F1 become too wet, the fibers F1 could flatten, which would reduce the abrasive surface area of the fibers, and/or the fibers F1 could collect fluid, which would increase the weight of the particles, and cause the particles to slow down.

The shape(s), size(s), and/or material(s) of the organic particles used at (368) may be selected in any suitable manner. For instance, in one embodiment, an operator may select via the user interface(s) 310 the appropriate shape(s), size(s), and/or material(s) of the organic particles and/or the shape(s), size(s), and/or material(s) of the organic particles may be loaded into the organic particle reservoir(s) 106.

As described above, in some instances, organic particles having different shapes are used simultaneously. In some instances, organic particles of a first shape are used in a first time frame and/or first injection location, and organic particles of a second shape are used in a second time frame and/or second injection location. The first time frame may only partially overlap the second time frame. The second injection location may be separate from the first injection location. The first shape may be different from the second shape. However, in some instances, only organic particles having the same initial shape are used, such as to generate a more uniform flow of organic particles.

As similarly described above, in some instances, organic particles having different average sizes are used simultaneously. In some instances, organic particles of a first size range are used in a first time frame and/or first injection location, and organic particles of a second size range are used in a second time frame and/or second injection location. The first time frame may only partially overlap the second time frame. The second injection location may be separate from the first injection location. The first size range may only partially overlap the second size range. However, in some instances, only organic particles having the same initial size range are used, such as to generate a more uniform flow of organic particles.

As additionally described above, in some instances, organic particles of different base and/or fiber materials may be used simultaneously. In some instances, organic particles of a first material and a first fiber material are used in a first time frame and/or first injection location, and organic particles of a second material and a second fiber material are used in a second time frame and/or second injection location. The first time frame may only partially overlap the second time frame. The second injection location may be separate from the first injection location. The first base material (e.g., sugar crystals) may be different than the second material (e.g., walnut shells). The first fiber material (e.g., kapok fibers) may be different from the second fiber material (e.g., coconut fibers). However, in some instances, only organic particles having the same materials are used, such as to generate a more uniform flow of organic particles.

Moreover, as described above, in some instances, the gas turbine engine 10 may be configured to rotate during the cleaning process. For instance, the computing device(s) 302 may be configured to control the operation of the external rotation source(s) 118 and/or the gas turbine engine 10 to rotate the gas turbine engine 10 within the cleaning speed range.

In some instances, the organic particles with the fibers F1 are electrostatically charged. More particularly, due to the interaction of fine dust particles with air or the gas turbine engine 10 during cleaning, the fine dust particles may become charged. As such, it may be beneficial for the organic particles to have a charge opposite to the charge of the fine dust particles to attract to the fine dust particles. In such instance, as the gas turbine engine 10, or part thereof, being cleaned may be electrically grounded, a fine mist may be applied to the gas turbine engine 10, or part thereof being cleaned before the organic particles are supplied, such that the organic particles are not attracted to the gas turbine engine 10, or part thereof, instead of the fine dust particles. In some instances, the computing device(s) 302 may control the delivery system(s) 108 to distribute liquid from the liquid reservoir(s) 104 as a mist. In one or more instances, the computing device(s) 302 may control the charge source(s) 116 such that the organic particles with the fibers F1 are electrostatically charged. The electrostatically charged organic particles with the fibers F1 may particularly be helpful when removing fine dust within, but near openings for cooling circuits. More particularly, the electrostatically charged organic particles are too large to enter the cooling circuits, but the electrostatic charge may be large enough to attract fine dust within the within, but near the openings for cooling circuits.

Additionally, in some instances, the vibration source(s) 114 may be controlled (e.g., by the computing device(s) 302) to apply vibrations to the organic particles within the organic particle reservoir(s) 106 to help separate the organic particles from each other for dispersion in the delivery medium (e.g., air). In instances where the organic particles with the fibers F1 have the same electrostatic charge, the organic particles with the fibers F1 may repel each other, and thus, may not require the vibration to be applied.

After performing cleaning with the organic particles with the fibers F1 at (368), the cleaning control algorithm 350 may return to (366) to determine if fine dust is still present. The cleaning control algorithm 350 may repeat the cleaning at (368) with the organic particles with the fibers F1 until fine dust is no longer determined to be present, at which point, the cleaning control algorithm 350 may end at (358).

In some instances, the charged organic particles are given a first period of time to interact with the fine dust particles before being removed from the gas turbine engine 10. For instance, the charged organic particles may be dispensed then air supply (e.g., fan rotation, etc.) may be stopped for a first period of time, where the first period of time may be from about three minutes to about fifteen minutes, to allow the charged organic particles more time to interact with the fine dust. After the first period of time, a rinse operation is subsequently performed. For instance, the rinse operation may include dispensing a foamed cleaning medium (e.g., foamed detergent) which is charged opposite to the charge of the organic particles, such that the foamed detergent may attract the initial charged organic particles and/or fibers. In some instances, the rinse operation may subsequently include dispensing a foamed detergent with a neutral charge at sufficient flow rates to remove the initial charged residue particles and/or fibers F1 attracted to the dust in the oppositely charged foamed detergent from the gas turbine engine 10. Alternately, as described above, the residual charged particles and/or fibers F1, which are organic in nature, will burn off when the temperature within the gas turbine engine 10 rises during regular operation.

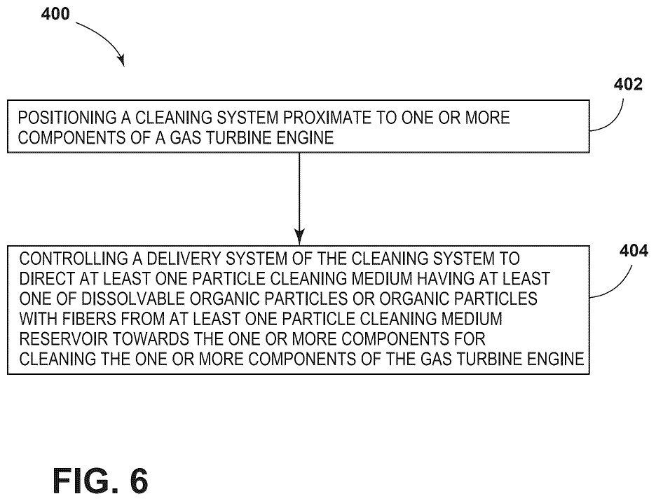

Referring now to FIG. 6, FIG. 6 illustrates a flow diagram of one embodiment of a method 400 for cleaning gas turbine engines in accordance with an exemplary aspect of the present disclosure. In general, the method 400 will be described with reference to the gas turbine engine 10 described with reference to FIG. 1, the cleaning system 100 described with reference to FIGS. 2-3, the computing system 300 described with reference to FIG. 4, and the cleaning control algorithm 350 described with reference to FIG. 5. However, it should be appreciated that the disclosed method 400 may be implemented with gas turbine engines having any other suitable configurations, with computing systems having any other suitable system configurations, and/or with any suitable control algorithms. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (402), the method 400 may include positioning a cleaning system proximate to one or more components of a gas turbine engine. For instance, as described above, the cleaning system 100 may be positioned proximate one or more components of the gas turbine engine 10 such that the cleaning system 100 may be used to clean the gas turbine engine 10 (e.g., in-situ), or components thereof (e.g., while removed from the gas turbine engine 10).

At (404), the method 400 may include controlling a delivery system of the cleaning system to direct at least one particle cleaning medium having at least one of dissolvable organic particles or organic particles with fibers from at least one particle cleaning medium reservoir towards the one or more components for cleaning the one or more components of the gas turbine engine. For instance, as discussed above, the delivery system(s) 108 of the cleaning system 100 may be controlled (e.g., by the computing device(s) 302) to direct at least one particle cleaning medium from at least one of the particle cleaning medium reservoirs 106 towards the gas turbine engine 10, or components thereof, to be cleaned. The at least one particle cleaning medium particularly includes at least one of a first plurality of organic particles or a second plurality of organic particles, where each of the first plurality of organic particles is dissolvable, and where each of the second plurality of organic particles has fibers.

Further aspects are provided by the subject matter of the following clauses:

The present disclosure provides a system for cleaning gas turbine engines, the system including at least one particle cleaning medium reservoir for storing at least one particle cleaning medium, the at least one particle cleaning medium including at least one of a first plurality of organic particles or a second plurality of organic particles, each of the first plurality of organic particles being dissolvable, each of the second plurality of organic particles having fibers; and a delivery system being configured to direct the at least one particle cleaning medium from the at least one particle cleaning medium reservoir towards one or more components of a gas turbine engine for cleaning the one or more components of the gas turbine engine.

The system of any preceding clause, wherein the fibers are at least one of coconut fibers, Kapok fibers, or cotton fibers.

The system of any preceding clause, wherein each of the second plurality of organic particles includes a base material and the fibers, the base material being insoluble.

The system of at least the preceding clause, wherein the base material includes at least one of coconut shell, nut shell, bamboo, fruit pit stone, or camphor.

The system of any preceding clause, wherein the first plurality of organic particles includes at least one of sugar crystals or honey crystals.

The system of any preceding clause, further including at least one further reservoir storing at least one further cleaning medium, the at least one further cleaning medium including at least one of a detergent cleaning medium or a liquid cleaning medium, wherein the delivery system is configured to direct the at least one further cleaning medium towards the one or more components of the gas turbine engine for cleaning the one or more components of the gas turbine engine after directing the first plurality of organic particles towards the one or more components of the gas turbine engine.

The system of at least the preceding clause, wherein the delivery system includes a charge source, the charge source being configured to electrostatically charge at least one of the particle cleaning medium or the one of the at least one further cleaning medium.

The system of any preceding clause, wherein the delivery system includes a charge source, the charge source being configured to electrostatically charge the particle cleaning medium.

The system of any preceding clause, wherein the delivery system includes a vibration source, the delivery system being configured to apply vibrations to the particle cleaning medium within the at least one particle cleaning medium reservoir.

The present disclosure provides a method for cleaning gas turbine engines, the method including positioning a cleaning system proximate to one or more components of a gas turbine engine; and controlling a delivery system of the cleaning system to direct at least one particle cleaning medium from at least one particle cleaning medium reservoir towards the one or more components for cleaning the one or more components of the gas turbine engine, the at least one particle cleaning medium including at least one of a first plurality of organic particles or a second plurality of organic particles, each of the first plurality of organic particles being dissolvable, each of the second plurality of organic particles having fibers.

The method of any preceding method clause, further including controlling the delivery system to direct a further cleaning medium from a further reservoir of the cleaning system towards the one or more components, the further cleaning medium including at least one of a detergent cleaning medium or a liquid cleaning medium.

The method of any preceding method clause, further including controlling the delivery system to direct insoluble organic particles from the at least one particle cleaning medium reservoir in the further cleaning medium from the further reservoir of the cleaning system towards the one or more components.

The method of any preceding method clause, wherein controlling the delivery system to direct the further cleaning medium towards the one or more components includes controlling the delivery system to direct the further cleaning medium towards the one or more components after controlling the delivery system to direct the first plurality of organic particles towards the one or more components.

The method of any preceding method clause, further including controlling a charge source of the delivery system to electrostatically charge at least one of the particle cleaning medium or the further cleaning medium.

The method of any preceding method clause further including: controlling a charge source of the delivery system to electrostatically charge the one or more components and at least one of the particle cleaning medium or the further cleaning medium with a same charge before the at least one of the particle cleaning medium or the further cleaning medium is received at the one or more components; and controlling the charge source of the delivery system to electrostatically charge the one or more components with a charge opposite the at least one of the particle cleaning medium or the further cleaning medium after the at least one of the particle cleaning medium or the further cleaning medium is received at the one or more components.

The method of any preceding method clause, further including controlling a charge source of the delivery system to electrostatically charge the particle cleaning medium.

The method of any preceding method clause, wherein the delivery system includes a vibration source, the delivery system being configured to apply vibrations to the particle cleaning medium within the at least one particle cleaning medium reservoir.

The method of any preceding method clause, wherein controlling the delivery system to direct the at least one particle cleaning medium towards the one or more components includes controlling the delivery system to direct the second plurality of organic particles towards the one or more components after directing the first plurality of organic particles towards the one or more components.

The method of any preceding method clause, wherein controlling the delivery system to direct the at least one particle cleaning medium towards the one or more components includes controlling the delivery system to direct the first plurality of organic particles towards the one or more components; controlling the delivery system to direct a further cleaning medium from a further reservoir of the cleaning system towards the one or more components after controlling the delivery system to direct the first plurality of organic particles towards the one or more components, the further cleaning medium including at least one of a detergent cleaning medium or a liquid cleaning medium; and controlling the delivery system to direct the second plurality of organic particles towards the one or more components after controlling the delivery system to direct the first plurality of organic particles towards the one or more components.

The method of at least the preceding method clause, further including controlling the delivery system to perform a drying operation to dry the one or more components after controlling the delivery system to direct the further cleaning medium towards the one or more components, wherein controlling the delivery system to direct the second plurality of organic particles towards the one or more components includes controlling the delivery system to direct the second plurality of organic particles towards the one or more components after controlling the delivery system to perform the drying operation.

The method of at least the preceding method clause, further including controlling the delivery system to direct a foamed cleaning medium towards the one or more components after at least a first time period elapses after controlling the delivery system to direct the second plurality of organic particles towards the one or more components, the foamed cleaning medium having a charge that is neutral or opposite of the second plurality of organic particles.

The present disclosure provides a gas turbine engine cleaning assembly, the assembly including a gas turbine engine defining one or more openings; and a cleaning system. The cleaning system includes at least one particle cleaning medium reservoir storing at least one particle cleaning medium, the at least one particle cleaning medium including at least one of a first plurality of organic particles or a second plurality of organic particles, each of the first plurality of organic particles being dissolvable, each of the second plurality of organic particles having fibers; and a delivery system in fluid communication with the at least one particle cleaning reservoir and the one or more openings of the gas turbine engine to direct the at least one particle cleaning medium from the at least one particle cleaning medium reservoir through the one or more openings towards one or more components of the gas turbine engine for cleaning the one or more components of the gas turbine engine.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for cleaning gas turbine engines, the system comprising:
at least one particle cleaning medium reservoir for storing at least one particle cleaning medium, the at least one particle cleaning medium comprising at least one of a first plurality of organic particles or a second plurality of organic particles, each of the first plurality of organic particles being dissolvable, each of the second plurality of organic particles having fibers; and
a delivery system being configured to direct the at least one particle cleaning medium from the at least one particle cleaning medium reservoir towards one or more components of a gas turbine engine for cleaning the one or more components of the gas turbine engine.

2. The system of claim 1, wherein the fibers are at least one of coconut fibers, Kapok fibers, or cotton fibers.

3. The system of claim 1, wherein each of the second plurality of organic particles comprises a base material and the fibers, the base material being insoluble.

4. The system of claim 3, wherein the base material comprises at least one of coconut shell, nut shell, bamboo, fruit pit stone, or camphor.

5. The system of claim 1, wherein the first plurality of organic particles comprises at least one of sugar crystals or honey crystals.

6. The system of claim 1, further comprising at least one further reservoir storing at least one further cleaning medium, the at least one further cleaning medium comprising at least one of a detergent cleaning medium or a liquid cleaning medium,
wherein the delivery system is configured to direct the at least one further cleaning medium towards the one or more components of the gas turbine engine for cleaning the one or more components of the gas turbine engine after directing the first plurality of organic particles towards the one or more components of the gas turbine engine.

7. The system of claim 6, wherein the delivery system includes a charge source, the charge source being configured to electrostatically charge at least one of the particle cleaning medium or the one of the at least one further cleaning medium.

8. The system of claim 1, wherein the delivery system includes a vibration source, the delivery system being configured to apply vibrations to the particle cleaning medium within the at least one particle cleaning medium reservoir.

9. A method for cleaning gas turbine engines, the method comprising:
positioning a cleaning system proximate to one or more components of a gas turbine engine; and
controlling a delivery system of the cleaning system to direct at least one particle cleaning medium from at least one particle cleaning medium reservoir towards the one or more components for cleaning the one or more components of the gas turbine engine, the at least one particle cleaning medium comprising at least one of a first plurality of organic particles or a second plurality of organic particles, each of the first plurality of organic particles being dissolvable, each of the second plurality of organic particles having fibers.

10. The method of claim 9, further comprising controlling the delivery system to direct a further cleaning medium from a further reservoir of the cleaning system towards the one or more components, the further cleaning medium comprising at least one of a detergent cleaning medium or a liquid cleaning medium.

11. The method of claim 10, further comprising controlling the delivery system to direct insoluble organic particles from the at least one particle cleaning medium reservoir in the further cleaning medium from the further reservoir of the cleaning system towards the one or more components.

12. The method of claim 10, wherein controlling the delivery system to direct the further cleaning medium towards the one or more components comprises controlling the delivery system to direct the further cleaning medium towards the one or more components after controlling the delivery system to direct the first plurality of organic particles towards the one or more components.

13. The method of claim 10, further comprising controlling a charge source of the delivery system to electrostatically charge at least one of the particle cleaning medium or the further cleaning medium.

14. The method of claim 10, further comprising:
controlling a charge source of the delivery system to electrostatically charge the one or more components and at least one of the particle cleaning medium or the further cleaning medium with a same charge before the at least one of the particle cleaning medium or the further cleaning medium is received at the one or more components; and
controlling the charge source of the delivery system to electrostatically charge the one or more components with a charge opposite the at least one of the particle cleaning medium or the further cleaning medium after the at least one of the particle cleaning medium or the further cleaning medium is received at the one or more components.

15. The method of claim 9, further comprising controlling a charge source of the delivery system to electrostatically charge the particle cleaning medium.

16. The method of claim 9, wherein controlling the delivery system to direct the at least one particle cleaning medium towards the one or more components comprises controlling the delivery system to direct the second plurality of organic particles towards the one or more components after directing the first plurality of organic particles towards the one or more components.

17. The method of claim 9, wherein controlling the delivery system to direct the at least one particle cleaning medium towards the one or more components comprises:
controlling the delivery system to direct the first plurality of organic particles towards the one or more components;
controlling the delivery system to direct a further cleaning medium from a further reservoir of the cleaning system towards the one or more components after controlling the delivery system to direct the first plurality of organic particles towards the one or more components, the further cleaning medium comprising at least one of a detergent cleaning medium or a liquid cleaning medium; and
controlling the delivery system to direct the second plurality of organic particles towards the one or more components after controlling the delivery system to direct the first plurality of organic particles towards the one or more components.

18. The method of claim 17, further comprising controlling the delivery system to perform a drying operation to dry the one or more components after controlling the delivery system to direct the further cleaning medium towards the one or more components,
wherein controlling the delivery system to direct the second plurality of organic particles towards the one or more components comprises controlling the delivery system to direct the second plurality of organic particles towards the one or more components after controlling the delivery system to perform the drying operation.

19. The method of claim 17, further comprising controlling the delivery system to direct a foamed cleaning medium towards the one or more components after at least a first time period elapses after controlling the delivery system to direct the second plurality of organic particles towards the one or more components, the foamed cleaning medium having a charge that is neutral or opposite of the second plurality of organic particles.

20. A gas turbine engine cleaning assembly, the assembly comprising:
a gas turbine engine defining one or more openings; and
a cleaning system, the cleaning system comprising:
at least one particle cleaning medium reservoir storing at least one particle cleaning medium, the at least one particle cleaning medium comprising at least one of a first plurality of organic particles or a second plurality of organic particles, each of the first plurality of organic particles being dissolvable, each of the second plurality of organic particles having fibers; and
a delivery system in fluid communication with the at least one particle cleaning reservoir and the one or more openings of the gas turbine engine to direct the at least one particle cleaning medium from the at least one particle cleaning medium reservoir through the one or more openings towards one or more components of the gas turbine engine for cleaning the one or more components of the gas turbine engine.
